(19) United States
(12) Patent Application Publication
(10) Pub. No.: US 2006/0030470 A1
(43) Pub. Date: Feb. 9, 2006

(54) Devices and process for manufacturing and filling bags

(76) Inventors: Hans-Ludwig Voss, Tecklenburg (DE); Ruediger Grosse-Heitmeyer, Osnabrueck (DE)

Correspondence Address: JACOBSON HOLMAN, 400 SEVENTH STREET N.W., WASHINGTON, DC, 20004, US

(21) Appl. No.: 11/196,507

(22) Filed: Aug. 4, 2005

(30) Foreign Application Priority Data
Aug. 4, 2004 (DE) 10 2004 038 006.6

(51) Int. Cl. B31B 1/64

(52) U.S. Cl. 493/194

(57) ABSTRACT

The present invention relates to a process and a device for manufacturing and filling bags that are provided with grip holes and that are formed from tubular material. In known processes these grip holes are inserted into the material before it is wound up into rolls. This process step increases the expenses of the manufacturing and filling of bags provided with grip holes. The objective of the present invention is to propose a process and a device using which bags provided with grip holes can be manufactured and filled more cost-effectively.

The present invention is characterized in that, the tubular material (4) is unwound by an unwinding device (2, 3, 5) and fed to a bag-forming device (1) and that the unwound, tubular material (4) or the bags (27) are provided with grip holes (43) in the bag forming device (1).

The present invention relates to a process and a device for manufacturing and filling bags pursuant to the claims 1 and 13.

Bags are manufactured using, among others, the so-called Form, Fill and Seal Machines (referred to in the following description as FFS machines).

Such machines are disclosed in the published patents DE 199 33 486, EP 534 062, DE 44 23 964, DE 199 20478 and DE 199 36 660. The FFS machines have unwinding stations on which film tubes are stored. These unwinding stations unwind the film tubes and separate them into film tube segments. Usually in the later process steps, the film tubes are provided with bottoms, the resulting bag is filled with the filling material and the bag is sealed. The type of bag forming and filling suggested in the afore-mentioned published patents is also a part of the contents of this disclosure. The same applies to the provisions of the term “Form, Fill and Seal machines” (FFS) and also the processes of transporting the film tubes, film segments and bags into these machines. As a rule, these machines are used to fill the bags with bulk materials.

Usually, film tubes are formed by blown film extrusion for the purpose of processing using FFS machines. The format of these film tubes (here, their periphery) is in agreement with the bag formed. This approach necessitates the relatively frequent and expensive replacement of formats in the blown film extrusion plants for the purpose of realizing different bag formats. For the purpose of carrying out the process of format replacement more cost-effectively, very often very broad film webs are manufactured by flat film extrusion or by blown film extrusion using machines of a bigger format. The resulting film tubes or film webs of a big format are then processed further into flat film webs by cutting them as per the format required. Subsequently, these laid flat film webs are folded up and joined by a longitudinal weld seam to form a film tube. Winding devices are associated with the described manufacturing processes for tubular films. After the film webs are manufactured or after additional processing steps (e.g., printing), these winding devices roll up the film webs into rolls, which then can be transported conveniently.

Different products are filled in the bags that are manufactured from these film webs. Even products of the consumer goods industry are included among these products that are filled in the described bags and using the described FFS machines. The bags filled with consumer goods are frequently sold by the retail trade and are therefore usually of a higher value. For facilitating the transport for the end customer the bags are usually provided with grip holes. In known manufacturing processes, such grip holes are inserted into the tubular film before it is rolled up into rolls.

However, the disadvantage is that the length of the bags formed subsequently must be known already at the time of insertion of the grip holes, even if the film is processed much later into bags. This increases the costs of storage since films for different bag formats have to be stored. Furthermore, another disadvantage is that grip holes are inserted into the film, which is manufactured, processed further (e.g., printed) or rolled up in a continuous process. Such manufacturing-, processing- and winding devices, which are equipped with means for inserting the grip holes into the film, are mechanically laborious and thus expensive.

Thus the objective of the present invention is to propose a process and a device using which bags provided with grip holes can be manufactured more cost-effectively.

According to the invention this objective is achieved by a process having the features that are specified in the characteristics of claim 1 and by a device having the features that are specified in the characteristics of claim 10.

According to the process and device suggested by the present invention, the tubular material is unwound by an unwinding device and fed to a bag-forming device and the unwound, tubular material or the bags are provided with grip holes in the bag forming device.

Grip holes are formed by cutting out or punching out the material from the tubular film. However, even simple cuts can be inserted into the film so as to form flaps that are firmly joined to the remaining material. The grip holes that are determined in this manner are formed completely when the flaps are turned over, for instance when the bag is grasped for the first time through the grip holes.

Thus in the process according to the present invention the grip holes are inserted into the bags or the tubular segments from the tubular film before, while or even shortly after these are manufactured. For the purpose of manufacturing the bags or the tubular segments the film must be transported in cycles or intermittently. Therefore it is particularly advantageous to carry out the process of forming the grip holes during these cycles.

In order to process the tubular material into bags, it is advantageous to seal one end of the bag using one or more cross welds over the entire width of the film. Cross welds can be formed with particular ease on material that is still tubular since it is possible to grasp this material at different places using grippers, pliers or similar holding instruments.

For the same reason it is recommended to make the grip holes even before the material is separated into tubular segments. In doing so, the grip holes can be formed even before the cross weld seams are formed. Moreover, the tubular material can be provided with diagonal welds before or after the grip holes are inserted into it. On the bags to be formed subsequently, these diagonal welds form so-called corner welds that increase the stability of the bags.

In an advantageous embodiment of the present invention, the bags can also be filled in the bag-forming device. A tubular segment that is held by holding instruments for the purpose of forming cross welds and grip holes can be fed by these or additional holding instruments to a filling device. The time-consuming steps of depositing, storing and again collecting the tubular segments are thus totally omitted. Holding instruments designed as grippers effectively transport the tubular segments through the bag-forming device. The grippers can be arranged in pairs such that each pair engages around the tubular segments laterally in the region of the upper edge. While doing so, it may become necessary to transfer the tubular segment from one pair of grippers to another pair of grippers. For this purpose transfer positions are provided in which both pairs of grippers hold the tubular segment for a short period of time. The tubular segments or the bags are transported in the horizontal direction for at least one half of their path, i.e., during every movement of the tubular segments or bags the horizontal path surpasses the vertical path.

In the bag-forming device the tubular material can be provided with grip holes during the downtime phases of the intermittent transport. The tools for providing the film with grip holes must be moved, in this case, only vertically to the film surface. Thus a movement component of these tools in the transport direction of the film is not necessary. This results in a mechanically simple design of the device for the execution of the process according to the invention.

It is advantageous if contour welds are formed that surround the grip holes. These contours can then form closed curves on the film material. In this manner the grip holes are surrounded by welds so as to prevent any filling material from subsequently entering into the grip holes and leaking from the bag through the grip holes.

In a particularly advantageous embodiment of the present invention, the grip holes, cross weld seams and possibly even the additional welds are formed at the same time or at least within one work cycle. In a device that is suitable for this purpose all required tools are arranged with only a small distance from one another. Thus the tools for cross welding, forming the grip holes and the additional welds can be arranged on a tool carrier that is moved in relation to the film. It is understood that the individual tools can also be arranged on several tool carriers. Therefore very few additional components are required for the formation of the grip holes. These additional components are substantially limited to a knife or a punching tool and a backing seal.

It is particularly advantageous to use a side gusset tube. Indeed the process can also be executed using a simple tubular film. However, the use of a side gusset tube offers additional advantages such as, for instance, better handling and greater stability.

A device in accordance with the present invention has means for providing the tubular material or the bags with grip holes. These means have contour knives using which it is possible to create the grip holes. In a particularly advantageous embodiment of the invention, the contour of the contour knives represents an open curve, due to which the grip holes comprise of flaps that get folded or turned down only when the bag is grasped through the grip holes. Due to this measure the film material need not be punched out. Consequently, there is no waste material inside the device which otherwise would have to be removed using special equipment, for instance, a suction unit.

Additional exemplary embodiments of the present invention have been set forth in the following description and claims taken in conjunction with the drawings, of which:

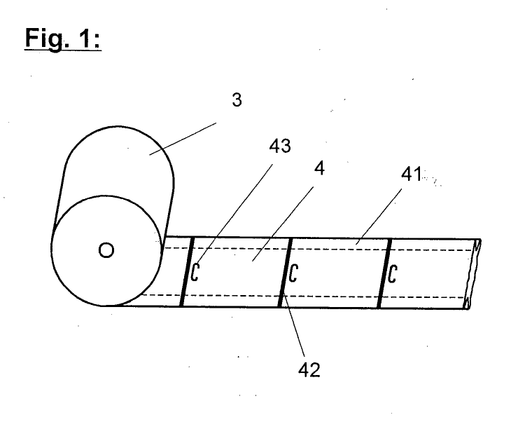

FIG. 1: illustrates a tubular film with side gussets and grip holes in accordance with the prior art

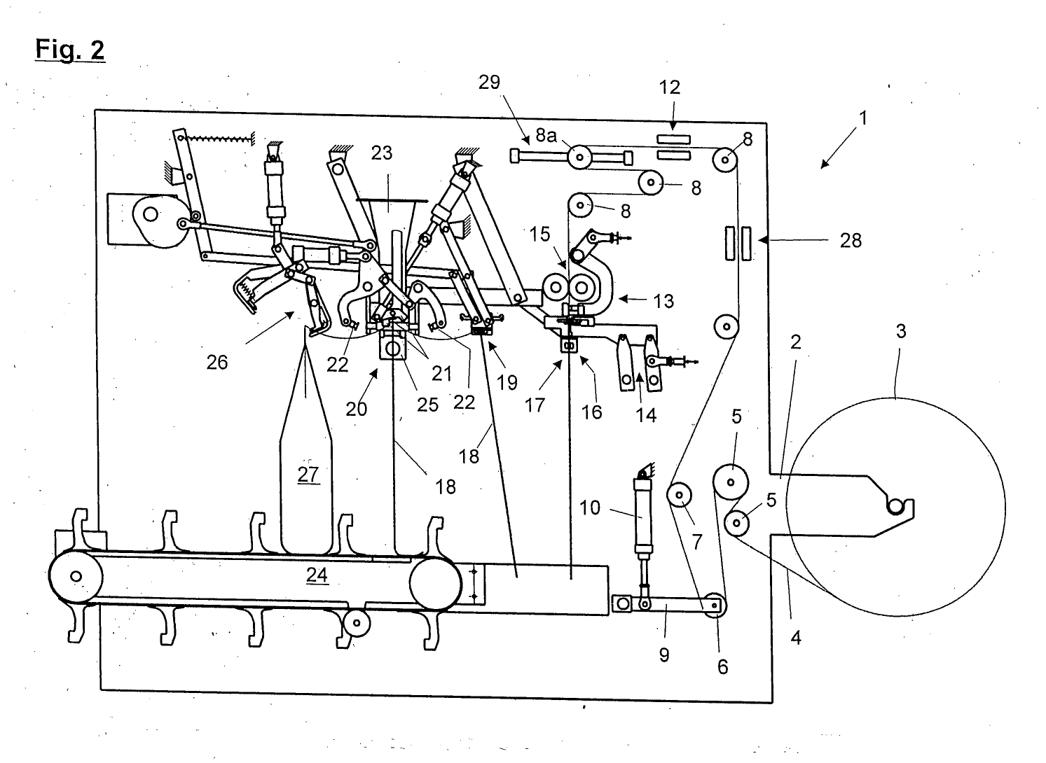

FIG. 2 illustrates a view of the device according to the invention

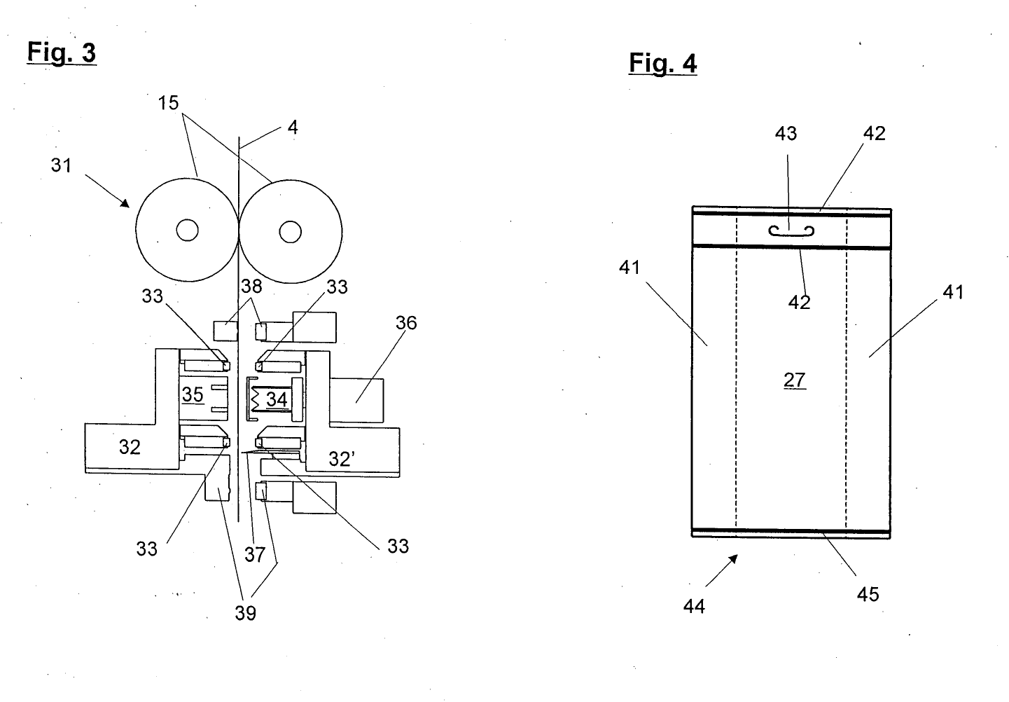

FIG. 3 illustrates a section of the device according to the invention

FIG. 4 illustrates a bag, which is manufactured using the process according to the invention

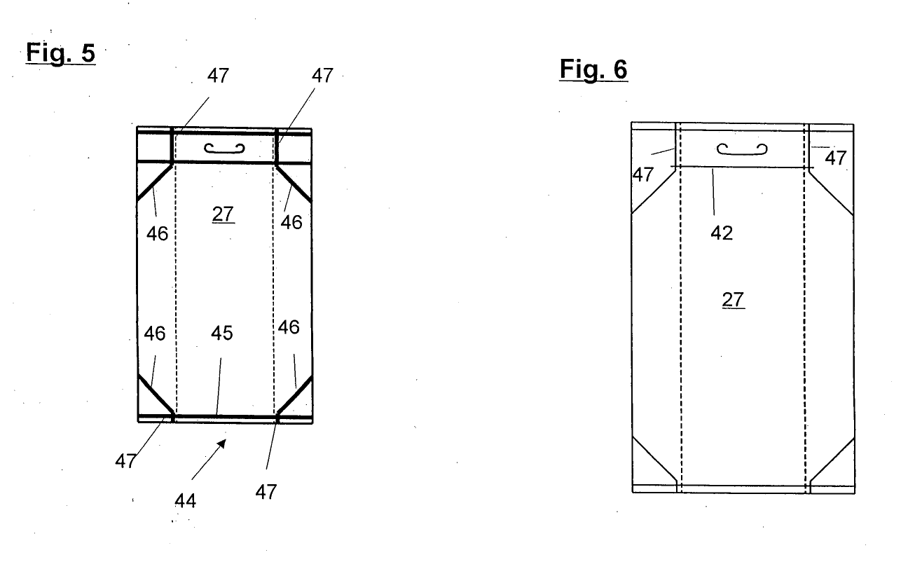

FIG. 5 illustrates a bag, which is manufactured using the process according to the invention

FIG. 6 illustrates a bag, which is manufactured using the process according to the invention

FIG. 7 illustrates a bag, which is manufactured using the process according to the invention

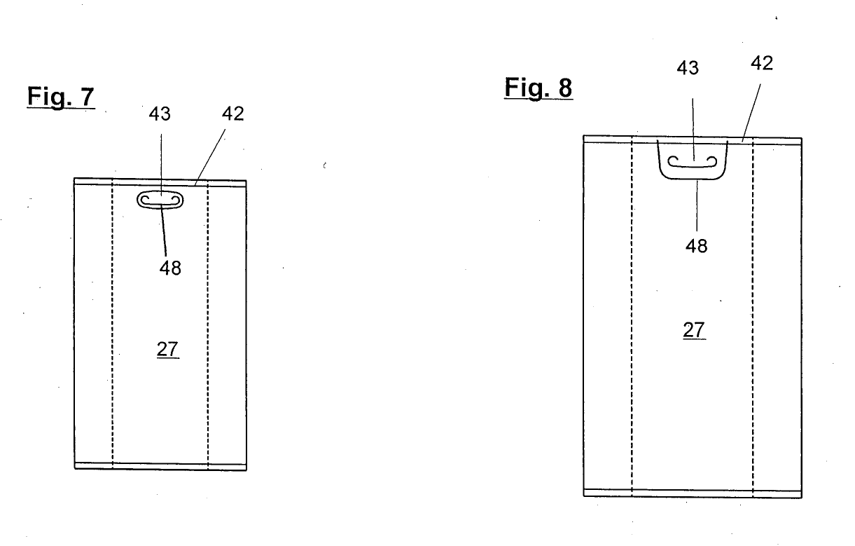

FIG. 8 illustrates a bag, which is manufactured using the process according to the invention

FIG. 1 illustrates a tubular film 4 with side gussets 41 according to the prior art and present in the form of a roll 3. This film 4 is intended for manufacturing bags that are subsequently filled with a filling material. Before being wound up into a roll, the tubular film 4 was provided with grip holes 43 in order to subsequently obtain bags provided with grip holes from this film. Furthermore, the tubular film 4 was already provided with cross welds 42. The tubular film 4 is later separated into tubular segments 18 parallel to these cross welds 42. Subsequently these tubular segments 18 are filled and sealed using an additional weld seam 48. The roll 3 of a thus prepared tubular film 4 is fed to a further processing device that manufactures tubular segments 18 from the film 4.

FIG. 2 illustrates a bag-forming device according to the present invention. This device 1 comprises of a carrier arm 2 supporting a roll 3 of tubular film 4. The tubular film 4 has side gussets that are not illustrated here. The transport rollers 5 that also can be driven to some extent allow the tubular film 4 to unwind, usually continuously. The lever 9 which is stressed by a load by means of a piston-cylinder unit 10 and which supports a deflecting roller 6 and is frequently referred to as a dancer device, the transport roller 7, 8 and the pair of feed rollers 15 allow, in an inherently known manner, for the tubular film 4 to be moved further on its further route of transport in cycles intermittently. The transport roller 8a is a component of a register device 29 using which the length of the transport route of the tubular film 4 can be adjusted to the format of the bags formed subsequently. For this purpose, the transport roller 8a is arranged such that it can be displaced in relation to the device 1. An inherently known spindle drive that is operated manually or by the electric motor is provided for the purpose of displacing the transport roller 8a.

In the course of its transport through the device 1, the tubular film 4 runs through a station 28 for inserting the grip holes 43. This station 28 comprises substantially of a punching or cutting tool 34 and a backing run 35. Moreover, the station 28 can also have means for adding welds, for instance, diagonal or corner welds 46 and/or contour welds. The punching or cutting operation and/or the welding operation takes place during the downtime phases of the intermittent transport. The tubular film 4 provided with grip holes 43 is conveyed by means of additional transport rollers 8 to a cooling station 12 in which the weld seams are cooled down.

Using the feed rollers 15, the tubular film 4 is pushed by the welding bar 33 of a cross welding station 13 through a cross cutting station 16. The tools of the cross welding station 13 and the cross cutting station 16 can be moved on the tubular film 4 in a manner that is not described in detail here, for instance using a parallelogram arrangement 14, in planes that are orthogonal to the feed direction of the tubular film 4 toward and away from the film 4. After the grippers 17 have grasped the tubular film 4, a tubular segment 18 is cut off in the cross cutting station 16 from the tubular film 4 above the grippers 17. Simultaneously, in the cross welding station 13 a cross weld is added to the tubular film 4 above its cut edge. This cross weld represents the bottom or the head side of the tubular segment 18 to be formed in the next work cycle of the device 1. In this context it must be mentioned that bags provided with grip holes are preferably filled from their bottom side so that they do not have to be filled through the region in which the grip holes are present. Accordingly, head seams are created in the cross welding station 13. In general, the head or bottom seams can be created using a cross weld, which however is the preferable but not the only option for creating the seams. Additional joining techniques, such as for instance gluing are also feasible.

The grippers 17 convey the tubular segment 18 to a transfer point at which additional grippers 19 grasp the tubular segment 18 and transport it to a filling station 20. There the tubular segment 18 is transferred to stationary grippers 21 and opened by the suction devices 22 so as to enable the filling material which is led by the filling pipe 23 to enter into the tubular segment 18. In doing so the tubular segment 18 lies with its lower end on a transport belt 24 so as to prevent it 18 from being loaded excessively along its longitudinal edges during the filling process. Additional grippers 25 convey the filled tubular segment 18 to the head or bottom seam welding station 26 in which the tubular segment 18 is sealed with a head or bottom weld seam and it thus forms a finished sack 27. It is also possible to use other joining techniques to seal the head region of the tubular segment 18. The finished bag is guided out of the device 1 by the transport band 24.

FIG. 3 illustrates a section of an additional embodiment of a device according to the invention using which the process pursuant to the present invention can be carried out. In addition to the pair of feed rollers 15, which provides for the transport of the tubular film 4 in a manner described above, this section also shows a cross welding, cross cutting and grip hole punching station 31 in place of the cross welding station 13 and the cross cutting station 16 illustrated in FIG. 2. In this embodiment, the station for inserting the grip holes 28 illustrated in FIG. 2 can be omitted. The cross welding, cross cutting and grip hole punching station 31 comprises of two tool carriers 32, 32′ that can be moved toward and away from the tubular film 4. Each of these tool carriers 32, 32′ carries two cross welding bars 33. The interaction of the two cross welding bars 33 lying opposite to one another results in adding a cross weld seam to the tubular film 4. In addition, a punching or cutting tool 34 is affixed to the tool carrier 32′. This punching or cutting tool 34 inserts a grip hole 43 in the tubular film 4. A backing run 35 is affixed to the tool carrier 32 for the purpose of supporting the film 4 during the punching or cutting process. For the punching or cutting process it may be necessary for the punching or cutting tool 34 to cover a path that stretches beyond the path of the tool carrier 32′. Therefore, the punching or cutting tool 34 can be displaced using a traversing unit 36 in relation to the tool carrier 32′. A piston-cylinder unit is used advantageously as the traversing unit 36. With the help of the cross cutting knife 37, a tubular segment 18 is cut off from the tubular film 4 which is also simultaneously provided with cross welds and grip holes in the cross cutting process. The tubular segment 18 was provided with cross welds and grip holes in the previous work cycle. In order to be able to hold the tubular film 4 immediately before the processing steps in the most central position possible between the tool carriers 32, 32′ and the tools 33, 34, 35, 37, the tubular film 4 is grasped for a short period of time earlier by the pair of grippers 38 and 39.

FIG. 4 illustrates a bag 27 which is either not driven or not available with a device 1 according to the FIG. 2 in which a cross welding, cross cutting and grip hole punching station 31 is arranged and the station for inserting the grip holes 28. This bag 27 has side gussets 41. It must be repeated at this point that the invention also refers to a process and a device using which even tubular material without side gussets can be processed. In the cross welding, cross cutting and grip hole punching station 31, the bag 27 and/or the tubular film 4 that subsequently forms the bag 27 are provided with two cross weld seams 42, that stretch over the entire width of the bag 27. Between these cross weld seams 42, a grip hole 43 is inserted into the tubular film 4. This grip hole 43 consists of a cut representing an open curve. The cut can be intercepted using bars so that the flap resulting due to the cut remains at the level of the film material till the bag is grasped for the first time through the grip hole 43. In this manner a disturbance in the subsequent transport or stacking operation is avoided effectively. The illustrated arrangement of the cross weld seams 42 and the grip hole 43 prevents the filling material, which is filled in through the lower end 44 of the bag 27, from leaking from the grip hole 43. After the bag 27 is filled, it is sealed in the head or bottom seam welding station 26 (see FIG. 2) with a bottom weld seam 45.

FIG. 5 illustrates an additional bag 27 which can be manufactured using the process according to the present invention and in a device 1 pursuant to the invention. This bag 27 corresponds to the bag illustrated in FIG. 4. However, it also has additional weld seams. These additional weld seams are corner welds 46 and longitudinal weld seams 47. The corner welds 46 and longitudinal weld seams 47 on the lower end 44 of the bag 27 are added preferably before the bag is filled. Comer welds 46 and longitudinal welds 47 can be provided particularly in case of heavy filling materials in order to minimize the forces on the points at which the cross weld seams 42, 45 are brought into contact with the outer edges of the bag, which usually represent the weak points of a bag 27.

FIG. 6 illustrates a variation of a bag according to FIG. 5. Here, the weld seam 42 (see FIG. 4), which is located at a distance from the head end of the bag, extends only between the longitudinal weld seams 47. In this manner the points of intersection of a cross weld seam and the outer edges of the bag 27 can be reduced.

FIG. 7 illustrates an additional bag 27. Here, the weld seam 42 (see FIG. 4) that is located at a distance from the head end of the bag is omitted. However, in order to prevent any filling materials from leaking from the grip hole 43 in this case too, the grip hole 43 is surrounded by a weld seam 48 forming a closed curve, which, for instance, can be elliptical-shaped.

FIG. 8 illustrates a variation of the bag 27 illustrated in FIG. 7. Here the weld seam 48 does not form any closed curve. Instead it forms an open curve that begins and ends at the cross weld seam 42. Thus in this case also, the grip hole 43 is completely surrounded by weld seams so as to prevent the leakage of any filler materials.

List Of Reference Symbols

| | |
|---|---|
| 1 | Device for manufacturing and filling bags |
| 2 | Support arm |
| 3 | Roll |
| 4 | Film |
| 5 | Transport roller |
| 6 | Deflecting roller |
| 7 | Transport roller |
| 8, 8a | Transport roller |
| 9 | Lever |
| 10 | Piston-cylinder unit |
| 11 | |
| 12 | Cooling station |
| 13 | Cross-welding station |
| 14 | Parallelogram arrangement |
| 15 | Feed roller pair |
| 16 | Cross-cutting station |
| 17 | Gripper |
| 18 | Tubular piece |
| 19 | Gripper |
| 20 | Filling station |
| 21 | Stationary gripper |
| 22 | Suction device |
| 23 | Filling pipe |
| 24 | Conveyor belt |
| 25 | Gripper |
| 26 | Head or bottom seam welding station |
| 27 | Bag |
| 28 | Station for inserting grip holes |
| 29 | Register device |
| 30 | |
| 31 | Cross-welding, cross-cutting and grip hole punching station |
| 32, 32′ | Tool carrier |
| 33 | Welding bar |
| 34 | Punching or cutting tool |
| 35 | Backing run |
| 36 | Traversing unit |
| 37 | Cross-cutting knife |
| 38 | Pair of grippers |
| 39 | Pair of grippers |
| 40 | |
| 41 | Side gusset |
| 42 | Cross weld seam |
| 43 | Grip hole |
| 44 | Lower end |
| 45 | Bottom weld seam |
| 46 | Corner weld |
| 47 | Longitudinal weld seam |
| 48 | Weld seam |

1. Process for manufacturing and filling bags that are provided with grip holes (43) and are formed out of tubular material (4), characterized in that, the tubular material (4) is unwound by an unwinding device (2, 3, 5) and fed to a bag-forming device (1) and that the unwound, tubular material (4) or the bags (27) in the bag-forming device (1) are provided with grip holes (43).

2. Process pursuant to claim 1, characterized in that, the process of forming the bags is executed in the bag-forming device (1) in that one end of the bag is formed by cross-welds (42, 45) in the tubular material (4).

3. Process pursuant to claim 1, characterized in that the bags are formed in the bag-forming device (1) by separating the tubular material (4) into tubular segments (18) after the tubular material (4) has been provided with grip holes (43).

4. Process pursuant to claim 1, characterized in that, even the process of filling the bags (27) is carried out in the bag-forming device (1).

5. Process pursuant to claim 1, characterized in that, the tubular segments (18) or the bags (27) are transported by grippers (17, 19, 25) at least during one part of their path in the bag-forming device (1).

6. Process pursuant to claim 5, characterized in that, the grippers (17, 19, 25) engage around the tubular segments (18) or the bags (27) in the region of their outer edges (31), where the tubular piece (18) or the bag (27) hangs down.

7. Process pursuant to claim 1, characterized in that, the tubular segments (18) or the bags (27) are transported horizontally at least for one half of their path.

8. Process pursuant to claim 1, characterized in that, the tubular material (4) in the bag-forming device (1) is provided with grip holes (43) during the downtime phases of the intermittent transport.

9. Process pursuant to claim 1, characterized in that, the tubular material is provided with diagonal welds (46).

10. Process pursuant to claim 1, characterized in that, the tubular material (4) is provided with contour welds (48), wherein closed curves (48) are formed that surround the grip holes (43).

11. Process pursuant to claim 2, characterized in that, the tubular material (4) is provided at least with cross welds (42) and grip holes (43) within one work cycle.

12. Process pursuant to claim 1, characterized in that, a side gusset film tube is used as the tubular material (4).

13. Device (1) for manufacturing and filling bags (27) that are provided with grip holes (43) and that can be manufactured from tubular material (4), characterized in, an unwinding station (2, 3, 5), which feeds the material (4) of which the sacks (27) comprise, in the form of tubular material (4) to the device and means (28, 34, 35, 36) for providing the tubular material (4) or the bags (27) with grip holes (43).

14. Device (1) pursuant to claim 13, characterized in that, the means (28, 34, 35, 36) for providing the tubular material (4) or the bags (27) with grip holes (43) have a contour knife (34).

15. Device pursuant to claim 14, characterized in that, the contour of the contour knife (34) represents an open curve.

16. Device pursuant to claim 13, characterized in that, at least one tool carrier (32, 32′) is provided that carries at least the means (28, 34, 35, 36) for providing the tubular material (4) or the bags (27) with grip holes (43) and that (32, 32′) can be moved in the direction of the tubular material (4) toward and away from it (4).

17. Device pursuant to claim 16, characterized in that, the tool carrier (32, 32′) additionally carries welding means (33) for creating cross weld seams (42) and cutting means (37) for separating the tubular material (4) into tubular segments (18).
